(19) United States
(12) Patent Application Publication
(10) Pub. No.: US 2009/0043922 A1
(43) Pub. Date: Feb. 12, 2009

(54) Method and Apparatus for Managing Media Storage Devices

(76) Inventor: David Aaron Crowther, Aloha, OR (US)

Correspondence Address: Joseph J. Laks;Thomson Licensing LLC, 2 Independence Way, Patent Operations, PO Box 5312, PRINCETON, NJ, 08543, US

(21) Appl. No.: 12/084,409

(22) PCT Filed: Nov. 2, 2006
(86) PCT No.: PCT/US2006/042825

§ 371 Date: Apr. 30, 2008

Related U.S. Application Data
(60) Provisional application No. 60/733,862, filed on Nov. 4, 2005.

(51) Int. Cl. G06F 13/00

(52) U.S. Cl. 710/33

(57) ABSTRACT

Increased efficiency within a system comprised of a plurality of storage devices (12₁ and 12₂) is achieved by evaluating each request to determine: (i) current storage status of the storage devices; (ii) storage capability of the storage devices; and (iii) at least one characteristic of the media block undergoing storage. Selection of one of the plurality of storage devices occurs in accordance with evaluating the write request. Thereafter the media block gets written to the selected storage device.

### CROSS-REFERENCE TO RELATED APPLICATIONS

This application claims priority under 35 U.S.C. 119(e) to U.S. Provisional Patent Application Ser. No. 60/733,862, filed Nov. 4, 2005, the teachings of which are incorporated herein.

### TECHNICAL FIELD

This invention relates to management of storage devices, such as storage area networks and the like, for storing media such as audio visual programs.

### BACKGROUND ART

Traditionally, fibre channel storage area networks, some times referred to as fibre channel SANs provided storage for audio visual programs in the form television programs and movies. Such audio visual programs typically include video, audio, ancillary data, and time code information. Professional users of such fibre channel SANs, such as television broadcasters; have generally relied on this type of storage because of very high performance and relatively low latency. Indeed, present day fibre channel SANs offer failure recovery times on the order of a few seconds or less. Unfortunately, the high performance and low latency of present day fibre channel SANs comes at a relatively high cost in terms of their purchase price and complexity of operation.

More recently Internet Protocol-based storage SANs, such as those making use of the Internet Small Computer Systems Interface (iSCSI) standard, have emerged as an alternative to fiber channel SANs. As compared to fiber channel SANs, iSCSI-based SANs offer much lower cost because iSCSI-based SANs make use of lower cost hardware. However, iSCSI-based SANs incur the disadvantage of high latency. As compared to most fibre channel SANs which have failure recovery times of a few seconds or less, present day iSCSI-based SANs have failure recovery times of 30 seconds or more. Such long recovery times serve as a deterrent to the adoption of iSCSI-based SANs for professional use.

Present day iSCSI-based SANs also suffer the disadvantage of being unable to provide any assurance as to their reliability for recording data. Professional users, such as television broadcasters, want an assurance that media recorded onto a storage device has actually been stored, without the need to check every asset after recording the media to the storage medium. Indeed, such professional users prefer a guarantee as to the integrity of the media being recorded notwithstanding any system failures that cause significant disruption to the data flow between the media server and the storage medium.

Thus a need exists for a storage technique that overcomes the aforementioned disadvantages of the prior art.

### BRIEF SUMMARY OF THE INVENTION

Briefly, in accordance with a preferred embodiment of the present principles, there is provided a method for increasing efficiency among a plurality of storage devices. The method commences by first evaluating a write request to write at least one media block for storage to determine: (i) current storage status of the storage devices; (ii) storage capability of the storage devices; and (iii) at least one characteristic of the media block undergoing storage. Selection of one of the plurality of storage devices occurs in accordance with evaluating the write request. Thereafter the media block gets written to the selected storage device.

### BRIEF DESCRIPTION OF THE DRAWINGS

FIG. 1 depicts a block schematic diagram of a controller, in accordance with an illustrative embodiment of the present principles, for increasing the efficiency of within a storage system;

FIG. 2 depicts a pair of storage devices of the type controlled by the controller of FIG. 1;

FIG. 3 depicts a state diagram illustrating the states associated with steady state operation of a pair of storage devices controlled by the controller of FIG. 1; and

FIG. 4 depicts a state diagram illustrating the states associated with slow storage device operation.

### DETAILED DESCRIPTION

As discussed in greater detail hereinafter, the efficiency within a storage system, such as a set of storage devices in a Storage Area Network (SAN), can be increased by maximizing the storage across the devices in accordance with the capacity and usage of the devices, and the nature of the data undergoing storage.

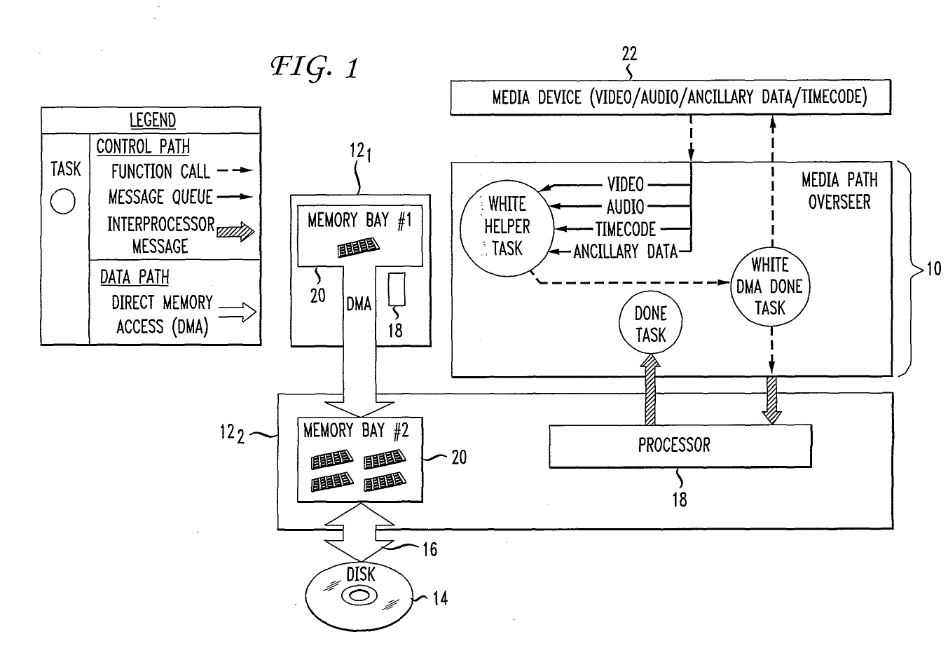

FIG. 1 depicts a controller 10, hereinafter referred to as a Media Path Overseer, for controlling storage of media blocks. In the illustrative embodiment of FIG. 1, the media path overseer 10 controls the storage of media blocks by efficiently managing the temporary storage of media blocks in a plurality of cache memories, illustratively depicted as cache memories 12₁ and 12₂, prior to storage in a disk 14 coupled to the cache memory 12₂ via an Internet Small Computer Systems Interface (iSCSI) protocol fabric 16. Although FIG. 1 depicts two cache memories 12₁-12₂ by way of example, the media path overseer 10 can easily control a larger number of cache memories as will become clear from the discussion hereinafter.

A typical cache memory, such as cache memory 12₁, comprises processor 18, such as a microprocessor or microcomputer that controls a memory bay 20 which provides temporary storage for a media block. The cache memories store one or more media blocks received from one or more media devices, illustratively represented by media device 22. A typical media device can generate or reproduce at one or more video streams, one or more associated audio streams, ancillary data and time code information.

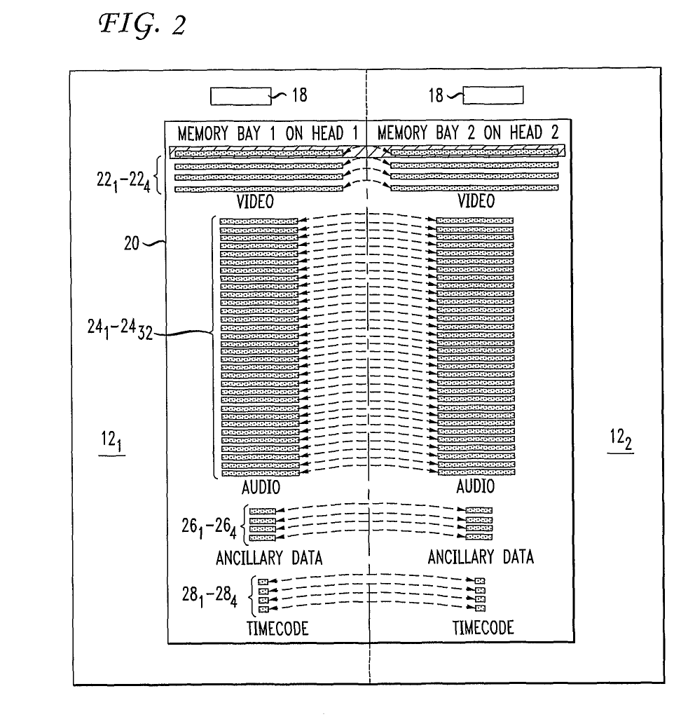

FIG. 2 depicts the virtual linkage of the memory bay 20 of a cache memory (e.g., cache memory 12₁) with the memory bay of another cache memory (e.g., cache memory 12₂).

In the case of a larger number of storage devices, a virtual connection will exist among the memory bays 20 of the cache memories. As shown in FIG. 2, the memory bay 20 within a given cache memory has a plurality of individual memory caches based on the type of media block and the number of media tracks (e.g., the number different streams of video and audio and accompanying ancillary data and time code information). For purposes of discussion, a media track within a media block comprises: (a) a video stream, (b) one or more associated audio streams, (c) an associated ancillary data segment; and (d) time code information associated with a given video stream.

In the illustrated embodiment of FIG. 2, the media blocks undergoing storage typically have four tracks. To accommodate such a media block comprised of four tracks, the memory bay 20 within a cache memory, such as cache memory 12₁, will have memory caches 24₁-24₄, for storing the four video streams, respectively. Typically, a given video stream has eight associated audio streams in different languages. Thus, the four video streams collectively have thirty-two associated audio streams stored in caches 26₁-26₃₂, respectively, of the memory bay 20. The ancillary data associated with a corresponding one of the four video streams undergoes storage in a corresponding one of caches 28₁-28₄, respectively in the memory bay 20. Lastly, the time code information associated a corresponding one of the four video streams undergoes storage in a separate one of caches 28₁-28₄ in the memory bay 20. For storage of media blocks having a greater or lesser number of tracks, a given memory bay 20 will require a greater or lesser number of caches, respectively.

Typical storage systems, such as the storage system of FIG. 1, will have a plurality of available cache memories. Typically, one of the cache memories, often referred to as the highest order cache memory, will possess a larger bandwidth coupling to the iSCSI fabric than the other cache memories of that client. In the illustrated embodiment of FIG. 1, the cache memory 12₂ possesses the largest bandwidth coupling to the iSCSI fabric 16 for transferring media blocks to the disk 14. Thus, greater efficiency results from writing media blocks to the highest order cache memory (i.e., cache memory 12₂) for subsequent writing to the disk 14 than by writing blocks from other (e.g., lower order) cache memories directly to the disk. For example, a media block currently residing in memory bay 20 of another cache memory (e.g., cache memory 12₁) will undergo a transfer to the memory bay 20 of the cache memory 12₂ for writing onto the disk 14 rather than being written from the cache memory 12₁ to the disk.

The writing of a media block from the media device 22 to the disk 14 occurs in the following maimer. Initially, one of the media devices (e.g., media device 22) issues a write request to write a media block to the disk 14. The media path overseer 10 receives the write request, and in response, places the request in one of a set of separate queues in a non-blocking manner. For a given write request extracted from a particular queue, the media path overseer 10 will evaluate the request based on: (i) current storage status of the storage devices; (ii) storage capability of the storage devices; and (iii) at least one characteristic of the media block undergoing storage.

With regard to the current status of the memory storage devices, the media path overseer takes into account the current storage capacity of the cache memories. In other words, the media path overseer 10 determines to what degree each of the cache memories In particular, the media path overseer 10 determines the fill state of the cache memories. In particular, the media path overseer determines the fill state of the highest order cache memory (e.g., cache memory 12₂) and the rate at which that cache memory drains media blocks to the disk 14. As for storage capability storage devices, the media path overseer takes into account the number of individual caches in the memory bay 20. The media path overseer 10 also evaluates the characteristics of each media block, as embodied in the write request, and particularly type and number of tracks, to determine which of the cache memories have the ability to store such a block.

The media path overseer 10 typically receives write requests from various media devices through their respective drivers. For the evaluation of various write requests, the media path overseer 10 can efficiently manages the temporary storage of the media blocks among the various cache memories. Additionally, the media path overseer takes into account the fact that media blocks undergo transfer from lower order cache memories (e.g., cache memory 12₁) to the highest order cache memory (e.g., cache memory 12₂) prior to writing to the disk 14. Thus, the available capacity of the highest order cache memory determines the ability of a lower order cache memory to transfer data for writing to the disk.

The media path overseer 10 executes a “write helper” task to extract write requests in associated with the various queues in a round-robin fashion. For a request to write to the disk 14 a media block first temporarily stored in the cache memory 12₁, the media path overseer 10 arranges for Direct Memory Address (DMA) transfer to the memory bay 20 of the highest order cache memory (e.g., cache memory 12₂) assuming capacity exists. Upon completion of the transfer to the memory bay 20 of the cache memory 12₂, the media path overseer 10 will alert the media device 22 which sent the block of the writing to the disk 14, even if the actual writing has not yet occurred. Knowing that the DMA transfer has occurred from the memory bay 20 of a lower order cache memory to the memory bay 20 of the highest order cache memory allows the writing of media blocks to the lower order cache memory (e.g., cache memory 12₁).

The memory bay 20 of the highest order cache memory (e.g., cache memory 12₂) now written with one or more media blocks, then proceeds to write the blocks to the disk 14. As discussed in greater detail below, the writing of media blocks from the highest order cache memory to the disk 14 occurs at a rate not exceeding twice the rate of the real time video stream encapsulated in the media block. Metering the rate at which the highest order cache memory writes to the disk 14 will reduce the likelihood of a surge during a time at which multiple clients flush their highest order cache memories for writing to the disk 14. In other words, metering the rate of writing to the disk 14 suppress surges so that other media servers (not shown) can make use of the iSCSI fabric 16 without disruption. Following writing to the disk 14, the media block then gets cleared from the memory bay 20 of the highest order cache memory (e.g., cache memory 12₂).

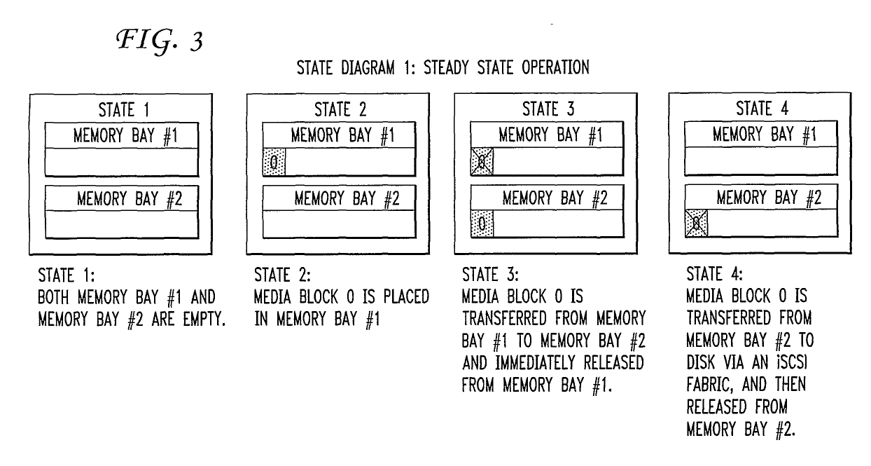

FIG. 3 depicts a state memory diagram showing a separate one of the four states associated with normal (steady state) operation DMA transfer from a lower order cache memory (e.g., cache memory) to the highest order cache memory (e.g., cache memory 12₂). At the outset, as represented by State 1 in FIG. 3, the memory bays 20 of the cache memories 12₁ and 12₂ remain empty. During the next phase (State 2), the memory bay 20 of the cache memory 12₂ gets written with a media block. Thereafter, as shown by State 3, the media block in the memory bay of cache memory 12₁ undergoes a transfer to the memory bay 20 of the cache memory 12₂ (e.g., the highest order memory bank) via a DMA transfer. Lastly, as shown in State 4, the media block gets written to the disk 14 of FIG. 1, and the memory bay 20 of the highest order cache memory gets cleared.

A discussed previously, the writing of a media block from the memory bay 20 of the highest order cache memory (e.g., cache memory 12₂ of FIG. 1) gets metered so that the writing occurs at a rate not exceeding twice the rate of the real time video stream encapsulated in the media block. Typically, media servers on an iSCSI network, such as the iSCSI fabric 16 of FIG. 1, actually constitute clients to one or more “bridge” servers. With multiple bridge servers, the iSCSI network traffic gets evenly distributed across each bridge server. In the event of a failure, such as the failure of a network component, switch, bridge server, port, etc., up to half of the media servers will “failover” to an alternate path within the network. This “failover” event can take up to 30 seconds or more. During this time, the virtually linked cache memories get filled, and at some point, they drain their stored media blocks to the highest order cache memory for ultimate transfer to the disk 14,

When the failover event completes and connectivity gets restored, up to half of the media servers have significantly filled their associated cache memories and must now drain their stored media blocks. However, if the stored media blocks all drain at once, a “surge” of data to the disk 14 would occur. This could lead to a potential disruption of the other half of the media servers still operating on the same iSCSI fabric 16.

To avoid disrupting other media servers on the same network, a surge protection technique, in accordance with an aspect of the present principles serves to dampen the effects media servers simultaneously draining their associated cache memories. The surge protection technique ensures that the virtually linked cache memories drain their stored media blocks at rates no faster than twice the steady state real time rate of transfer of media blocks. The surge protection technique must possess knowledge of the type of video encapsulated within the media blocks. Various types of video have different frame rate characteristics, giving rise to different rates at which media blocks drain to the disk 14.

In the illustrative embodiment, the following formula serves to determine the metering of the media blocks such that no disruption occurs to other media servers sharing the same network and storage medium:

$$τ = ( \frac{1000}{f * δ} ) - θ m . s .$$

### Where:

τ is the meter time in milliseconds;

ƒ is the video frame rate for the particular video type associated with a particular track and media cache;

δ is the drain rate beyond which the surge protection technique will not exceed-typically between 1.5 and 2.5, or in other words a 1.5x-2.5x the normal rate of a steady state track of video; and

θ is the average time (in milliseconds) that the storage medium consumes to service a request of this type.

Often times, media servers will coalesce video frames into a larger single input/output (I/O) request. Combining frames serves to maximize the performance of the storage medium. In such a case, the Surge Dampening formula takes the following form:

$$τ = ( \frac{1000 * η}{f * δ} ) - θ m . s .$$

Where τ, ƒ, δ, and θ are the same as above, and η is the number of video frames coalesced into a single larger I/O request.
   Typical frame rates ƒ for broadcast quality video include 60, 50, 30, 25, and 24 frames per second. Using one of these ƒ rates as an example, in the case where ƒ=30 frames per second, choosing a drain rate δ=2, where η=6 video frames per coalesced I/O request, and the average storage medium service time is θ=30, then each coalesced I/O request gets written to the disk 14 of FIG. 1 at a rate no faster than ((1000*6)/(30*2))−30 or approximately once every 70 milliseconds. It is important that δ is chosen to be always greater than 1, and preferably between 1.5 and 2.5. This ensures that the cache memories drain at a faster rate than they get filled, but not so fast as to interfere with other media servers immediately following a failure event.

Typically, media servers issue multiple outstanding I/O requests to the storage medium for a given media file. Issuing such multiple requests serves to increase performance by masking the typical transactional overhead that accompanies each request. In such a case, the Surge Dampening formula takes the following form:

$$τ = ( \frac{1000 * η * σ}{f * δ} ) - θ m . s .$$

The parameters τ, ƒ, δ, η, and θ remain the same as before, and π is the number of outstanding requests to this media file at the moment that the I/O request is issued. When multiple outstanding I/O requests get issued to a storage medium for a given file, the meter time τ for a given outstanding I/O request expires at more or less the same time as the other outstanding I/O requests to the same file. For example, consider a case where there are three outstanding I/O requests issued one right after the other to the same media file:

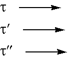

The meter times τ, τ′, and τ″ run concurrently, not serially. As such, it is important to incorporate this “masking” effect into the Surge Dampening formula above. By taking all of these factors into account, the Surge Dampening mechanism marshals the incoming media blocks and outgoing media blocks at an optimal rate for all parts of the system.

In practice, the processor 18 associated with the highest order memory cache (e.g., memory cache 12₂), which manages the final write transaction between the Memory Bay 20 and the disk 14, also implements the above-described surge protection technique. The surge protection technique runs continuously under both steady state and failure state conditions. Under steady state operation, write requests will never occur at a rate faster than 1× (real time). Therefore, the surge protection technique does not engage. In the absence of a surge of media blocks, the surge protection technique, though present, has no effect. However, in the case where the cache memories get full or partially fill, and become ready to drain to the disk 14 via the highest order cache memory, the surge protection technique attenuates the transferring of media blocks to the disk 14 according to the formulas above. The media blocks get metered by limiting write requests associated with a particular video track to one every τ amount of time. This does not impede the writing of media blocks associated with other media tracks, as metering of the tracks occurs individually.

Generally no need exists to meter the draining of audio, ancillary data, and time code information. In practice, the ratio of audio, ancillary data, and time code media blocks to video media blocks remains insignificant. Thus, any surge that could occur would exist on a much smaller scale and would not likely to disrupt other media servers. However, the surge protection technique described above could easily serve to meter the draining of audio, ancillary data and time code information as well.

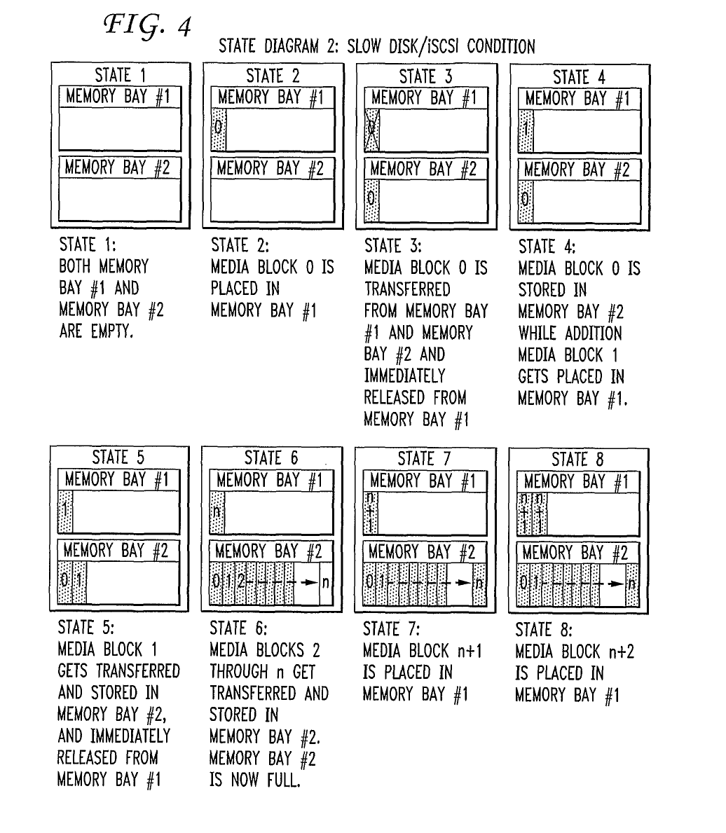

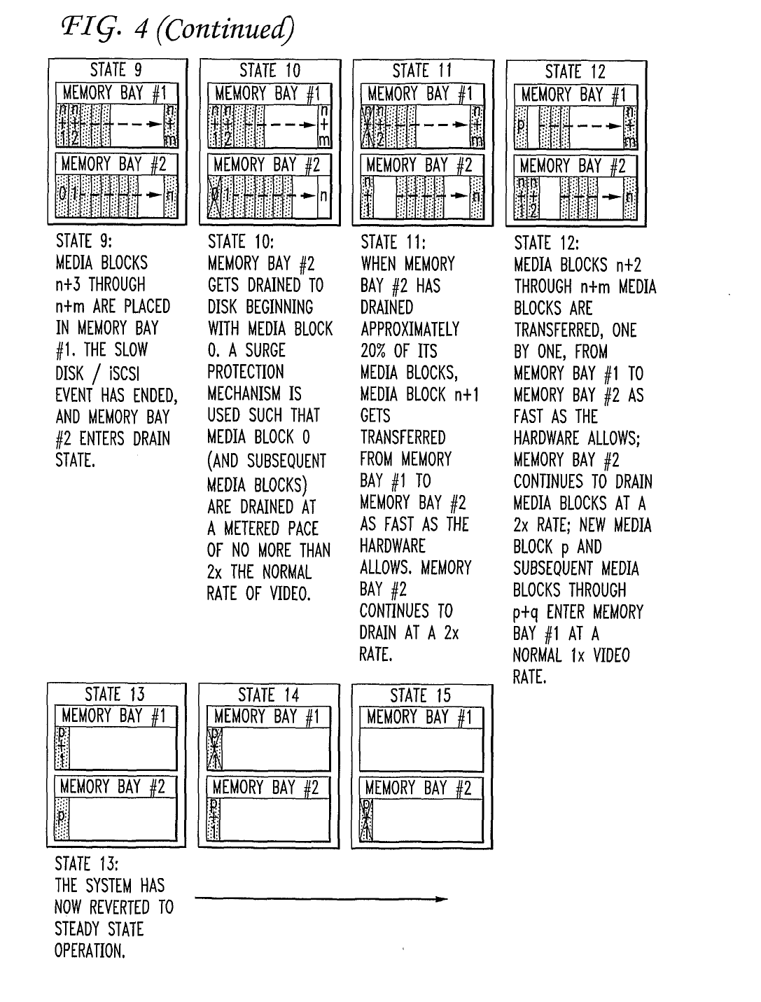

To appreciate how metering the rate of media block transfer using the surge protection technique of the present principles can prevent surges, refer to FIG. 4 which depicts a state diagram showing the various states associated with one or both of a slow disk 14 condition or a heavy influx of activity on the iSCSI fabric 16. At the outset, as represented by State 1 in FIG. 4, the memory bays 20 of the cache memories 12₁ and 12₂ remain empty. During the next phase (State 2), the memory bay 20 of the cache memory 12₂ gets written with a first media block, designated as media block 0 in FIG. 4. Thereafter, as shown by State 3, the media block 0 in the memory bay 20 of cache memory 12₁ undergoes a DMA transfer to the memory bay 20 of the cache memory 12₂ (e.g., the highest order memory bank). After the DMA transfer, the media block 0 in memory bay 20 of the cache memory 12₁ gets cleared.

During the next state (State 4), the memory bay 20 of the cache memory 12₁ gets written with another media bloc (block 1) while the first media block (block 0) remains in the memory bay 20 of the cache memory 12₂. During State 5, the media block 1 gets transferred from the memory bay 20 of the cache memory 12₁ to the memory bay of the cache memory 12₂. Following the transfer, the media block 1 gets cleared from the memory bay 20 of the cache memory 12₂. As indicated in State 6, the transfer of media blocks 2 through n continues in the manner previously described until the memory bay 20 of the cache memory 122 (the highest order cache memory) becomes full.

Assume for purposes of discussion at the outset of State 6, a slow disk or a congested iSCI fabric condition or both has occurred. The existence of such circumstances will at least impede the draining of media blocks to the disk 14 of FIG. 1. Even though the memory bay 20 of cache memory 12₂ has now become full at this time, the writing of media blocks to the memory bay 20 of the cache memory 12₁ can still occur since each media block transferred from that cache memory gets cleared after transfer. Thus, during State 7, media block n+1 (where n is an integer) gets written into the memory bay 20 of the cache memory 12₁. During State 8, media block n+2 gets written into the memory bay 20 of the cache memory 12₁. The process of writing additional media blocks into the memory bay 20 of the cache memory 12₁ continues until media block n+m gets written into the memory bay 20 of the cache memory 12₁ as indicated in State 9.

Assume that at State 10, the slow disk and/or congested iSCSI fabric condition(s) no longer exists and the stored media blocks in the memory bay 20 of the cache memory 12₂ can now begin to drain to the disk 14 of FIG. 1. Under such conditions, the surge suppression technique discussed above gets invoked to meter the draining of media blocks. Upon invoking the surge suppression technique, the media blocks in the memory bay 20 of the cache memory 12₂. beginning with block 0, get drained at a metered rate not exceeding twice the of the real time rate of the video streams encapsulated in the blocks.

After a certain percentage (e.g., 20%) of media blocks the memory bay 20 of the cache memory 12₂ get drained to the disk 14 of FIG. 1, DMA transfer of the media block n+1 from the memory bay 20 of the cache memory 12₁ to the cache memory 12₂ will occur as indicated in State 11. The transfer between cache memories 12₁ and 12₂ occurs as quickly as hardware allows. In contrast, the draining of media blocks from the memory bay 20 of the cache memory 12₂ (the highest order cache memory) to the disk 14 continues at the metered rate in the manner described previously. The transfer of media blocks one by one from the memory bay 20 of the cache memory 12₁ to the memory bay 20 of the cache memory 12₂ continues with media blocks n+1, through m+n. At the same time, the memory bay 20 of the cache memory 12₂ drains to the disk 14 at the metered rate. New media blocks, beginning with media block p, get written into the memory bay 20 of the cache memory 12₁. Beginning at State 13, steady state operation resumes with a new media block p+1 written into the memory bay 20 of the cache memory 12₁. Thereafter, the new media block p+1 in the memory bay 20 of the cache memory 12₁ undergoes a DMA transfer to the memory bay 20 of the cache memory 12₂ and gets cleared from the memory bay 20 of the cache memory 12₁ as shown in State 14. Finally, the new media block p+1 drains to the disk 14 during State 15. The steady state process of transferring a block from the memory bay 20 of the cache memory 12₁ to the memory bay 20 of the cache memory 12₂ and thereafter draining the media block to the disk continues until complete transfer of all blocks.

The foregoing describes a technique for efficiently managing storage of a plurality of storage devices. While the storage technique of the present principles has been described with respect to transferring media blocks from one of a plurality of lower order cache memories to one highest order cache memory, the technique equally applies to multiple higher order cache memories.

1. A method for increasing efficiency among a plurality of storage devices, comprising the steps of:
evaluating a write request to write at least one media block to a storage device to determine: (i) current storage status of the storage devices; (ii) storage capability of the storage devices; and (iii) at least one characteristic of the media block undergoing storage;
selecting one of the plurality of storage devices in accordance with evaluating the write request; and
writing the at least one media block to the selected storage device.

2. The method according to claim 1 further comprising the step of transferring the at least one media block from the selected storage device to a subsequent storage device.

3. The method according to claim 2 further comprising the step of clearing the selected storage device upon transfer of the at least one media block to the subsequent storage device.

4. The media according to claim 2 further comprising the step of writing the at least one media block from the subsequent storage device to a disk.

5. The method according to claim 4 further comprising the step of clearing the at least one media block from the subsequent storage device following writing of the at least one media block to the disk.

6. The method according to claim 4 further comprising the step of regulating the writing of the at least one media block from the subsequent storage device to a disk so the draining does not exceed a rate determined by a characteristic of the at least one media block.

7. The method according to claim 6 wherein the media block includes at least one encapsulated video stream and wherein the rate at which the media block drains to the disk is regulated so as not to exceed twice a real time rate of the video stream.

8. The method according to claim 4 wherein the transfer of at least one media block to the subsequent storage device and the writing of a media block to the disk occur within overlapping intervals.

9. The method according to claim 4 wherein the transfer of at least one media block to the subsequent storage device and the writing of a media block to the disk occur at different rates.

10. Apparatus comprising:
a plurality of storage devices for storing at least media block:
means for evaluating a request to write at least one media block to a storage device to determine: (i) current storage status of the storage devices; (ii) storage capability of the storage devices; and (iii) at least one characteristic of the media block undergoing storage;
means for selecting one of the plurality of storage devices in accordance with evaluating the write request; and
means for writing the at least one media block to the selected storage device.

11. The apparatus according to claim 10 wherein the storage devices comprise first order cache memories coupled to each other.

12. The apparatus according to claim 10 further comprising:
a second order cache memory coupled to selected storage device for receiving the at least one media block.

13. The apparatus according to claim 12 further comprising:
a disk for storing the at least one media block; and
a communications path coupling the second order cache memory to the disk.

14. The apparatus according to claim 13 wherein the communications path comprises an Internet Small Computer Systems Interface.

15. The apparatus according to claim 15 further including means for regulating writing of the at least one media block from the second order cache memory to the disk so the draining does not exceed a rate determined by a characteristic of the at least one media block.

16. The apparatus according to claim 15 wherein the media block includes at least one encapsulated video stream and wherein the regulating means regulates the rate at which the media block drains to the disk is regulated so as not to exceed twice a real time rate of the video stream.
